(19) United States
(12) Patent Application Publication
(10) Pub. No.: US 2026/0196191 A1
(43) Pub. Date: Jul. 9, 2026

(54) SYSTEM FOR A MUSICAL INSTRUMENT AND A METHOD THEREOF

(71) Applicant: Kyle Imgarten, Salisbury, MO (US)

(72) Inventor: Kyle Imgarten, Salisbury, MO (US)

(21) Appl. No.: 19/014,231

(22) Filed: Jan. 9, 2025

(51) Int. Cl. G10D 3/147; G10D 1/08; G10D 99/00

(52) U.S. Cl. CPC G10D 3/147; G10D 1/08; G10D 99/00

(57) ABSTRACT

A musical instrument control system is disclosed. The musical control system comprises a frame having a first portion and a second portion. Further, one or more pedal arrangements are installed at the first portion and the second portion of the frame and one or more lever arrangements are installed at one or more positions of the first portion of the frame. One or more sensors outputs one or more signals indicative of a movement of the one or more pedal arrangements and the one or more lever arrangements. At least one mounting chassis comprises a plurality of motors, each of the plurality of motors are coupled to each of the one or more sensors. Further, at least one microcontroller is configured to receive the one or more signals from the one or more sensors and one or more copedant settings, determine an angle, and selectively actuate the plurality of motors.

### FIELD OF THE DISCLOSURE

The invention relates to a musical instrument. More particularly, the invention relates to a system for a musical instrument and a method thereof.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different approaches related to editing, saving, and recalling copedant settings of a musical instrument by a user, wherein such system and method themselves may also correspond to implementations of the claimed technology and invention.

A pedal steel guitar is a type of electric guitar designed for a unique sliding sound, often used in country, blues, and Hawaiian music. Unlike standard guitars, it is played horizontally (lap-style) and has pedals and knee levers that allow the user to alter the pitch of individual strings. The pedal steel guitar is tuned with a specific copedant setting. The copedant setting refers to the specific configuration of a pedal steel guitar's tuning, pedals, and knee levers. Many pedal steel users develop custom copedant settings to suit their style, preferences, or specific musical requirements. Advanced users may modify their pedal setups to add more levers or pedals, adjust pitch changes, or create entirely unique tunings.

Further, a pedal steel guitar copedant setting is specified to the manufacturer by the client musician upon ordering the pedal steel guitar. The parts and pieces to achieve this copedant setting are then installed or fabricated, to achieve the desired copedant settings. However, there is no standard copedant settings which require users to set the copedant settings as per their preference. To modify the copedant settings, the pedal steel guitar may be mechanically modified. This could include disassembling and reassembling the parts in a different configuration, custom fabrication of parts, or shipping the pedal steel guitar to the manufacturer for the desired modifications. Such method is slow, costly, and highly inefficient. Also, such method does not allow trial and error if a musician modifies their copedant settings. Once the copedant settings are modified, then it is not easily, quickly, or economically reversed.

Prior art, for various aspects contained there within, relevant to this disclosure includes U.S. Pat. No. 11,437,005 B1 to Paul, U.S. Pat. Publication No. 20180053494 A1 to Alan, and U.S. Pat. No. 7,935,876 B1 to Raymond. In each of these prior arts, a musical instrument is disclosed that provide a many customizable tuning options for altering different aspects of the instrument. However, this is not an ideal solution to the problem for providing a pedal steel guitar whose copedant can be edited, saved, and recalled by the musician at their discretion and in which any pedal/lever/input can be assigned to any string to increase or decrease the pitch produced by that string.

In particular, reference '005 to Paul discloses a multi-stringed musical instrument, such as a guitar, having a neck with a partially hollow interior containing a number of linear actuators, each connected to a fret which projects proud of the neck and is in contact with a taught string, wherein the linear actuators are controlled by means of a user-selected input signal via functional communication with a small control panel, tablet, smartphone, computer or laptop. However, unlike the subject matter of the disclosed invention, Paul does not disclose about saving, editing, and recalling multiple copedant settings of the pedal steel guitar. Further, Paul does not disclose about any pedal/lever/input that can be assigned to any string to increase or decrease the pitch produced by that string. Further, Paul fails to disclose about strategically built chassis integrated with motors for adjusting pitch of the strings. Further, Paul fails to disclose about musical instrument control system that enables the user to play the instrument either in traditional seating configuration or standing configuration. Paul also fails to disclose about electronically sensing and observing multiple inputs from the user (in real time) over the pedals and levers of the instrument that can be further amplified, adjusted, or saved to enable ease in playing the instrument and improve versatility in playing the instrument.

Reference '494 to Alan discloses the pedal steel guitar having a plurality of strings strung across the body, with at least one multi-element transducer positioned proximate the strings. At least one foot pedal or knee lever, carried by the body and being physically disengaged from the plurality of strings, is coupled to at least one sensor that produces an electronic sensor signal when the pedal or lever is moved. A digital signal processor receives the electronic transducer signal and the electronic sensor signal and operates on the electronic transducer signal in the digital domain. The processor uses the electronic sensor signal to manipulate at least one tonal property of the electronic sensor signal. The digital signal processor produces an audio output. The digital signal processor is programmed to change the manner in which the digital signal processor manipulates the at least one tonal property based on programming information received through a programming input. However, unlike the subject matter of the disclosed invention, Alan does not disclose about saving, editing, and recalling multiple copedant settings of the pedal steel guitar. Further, Alan does not disclose about any pedal/lever/input that can be assigned to any string to increase or decrease the pitch produced by that string. Further, Alan fails to disclose about strategically built chassis integrated with motors for adjusting pitch of the strings. Further, Alan fails to disclose about musical instrument control system that enables the user to play the instrument either in traditional seating configuration or standing configuration. Although Alan does disclose about adjusting tonal property of the instrument based on programming information, however, Alan fails to disclose about electronically sensing and observing multiple inputs from the user (in real time) over the pedals and levers of the instrument that can be further amplified, adjusted or saved to enable ease in playing the instrument and improve versatility in playing the instrument.

Reference '876 to Raymond discloses a method and apparatus for string load reduction and real-time pitch alteration on stringed instruments. A string load is substantially reduced with a camming surface actuator so that the pitch can be rapidly manipulated by an input force which is generated by human power or an electronically controlled motor. Various types of camming surfaces are provided as well as a load optimization calculation which determines the shape of a variable ratio camming surface. Multiple embodiments are described including a constant force pitch alteration device, a motorized control system with pitch compensation and real-time tracking of string pitch to multiple relative input signals, a control signal generator based on real-time position measurement of a control object relative to an electromagnetic radiation sensor, and methods for generating mechanical looping, vibrato, and polyphonic chorus effects which can be automated or dynamically controlled by a user. Other embodiments are described and shown. However, unlike the subject matter of the disclosed invention, Raymond does not disclose about saving, editing, and recalling multiple copedant settings of the pedal steel guitar. Further, Raymond does not disclose about any pedal/lever/input that can be assigned to any string to increase or decrease the pitch produced by that string. Further, Raymond fails to disclose about strategically built chassis integrated with motors for adjusting pitch of the strings. Although Raymond does disclose about constant force pitch alteration device, however, Raymond fails to disclose about musical instrument control system that enables the user to play the instrument either in traditional seating configuration or standing configuration. Raymond fails to disclose about electronically sensing and observing multiple inputs from the user (in real time) over the pedals and levers of the instrument that can be further amplified, adjusted or saved to enable ease in playing the instrument and improve versatility in playing the instrument.

Given the deficiencies of the prior art, the need remains for an effective and a user friendly pedal steel guitar in which the copedant settings can be saved, changed, recalled, and also can be selected digitally without requiring to manually move the pedal, levers, and the strings of the pedal steel guitar.

### SUMMARY OF THE DISCLOSURE

According to embodiments illustrated herein, a novel, simple and interactive device and method thereof.

In some embodiments, the invention discloses about a strategically built chassis integrated with motors for adjusting the pitch of the strings of a musical instrument control system. Further, the invention enables a user to play an instrument of the musical instrument control system, either in traditional seating configuration or standing configuration. Further, in some embodiments, the invention discloses about any pedal/lever/input that can be assigned to any string to increase or decrease the pitch produced by that string. In some embodiments, the invention is configured to electronically sense and observe multiple inputs from the user (in real time) over the pedals and levers of the instrument that may be further amplified, adjusted or saved to enable ease in playing the instrument and improve versatility in playing the instrument. In some embodiments, the invention discloses about saving, editing, and recalling multiple copedant settings of the pedal steel guitar.

In some embodiments, a system is disclosed, the system comprises a frame having a first portion and a second portion. Further, the system comprises one or more pedal arrangements installed at the first portion and the second portion of the frame. Further, the system comprises one or more lever arrangements installed at one or more positions of the first portion of the frame. Further, the system comprises one or more sensors communicatively coupled to the one or more pedal arrangements and the one or more lever arrangements, wherein the one or more sensors are configured to output one or more signals indicative of a movement of the one or more pedal arrangements and the one or more lever arrangements. Further, the system comprises at least one mounting chassis installed at the first portion of the frame and comprising a plurality of motors, wherein each of the plurality of motors are communicatively coupled to each of the one or more sensors. Further, the system comprises at least one microcontroller communicatively coupled to each of the one or more sensors and each of the plurality of motors, wherein the at least one microcontroller is configured to receive the one or more signals from each of the one or more sensors and one or more copedant settings; determine an angle based on the received one or more signals, wherein the angle corresponds to an amount of rotational movement of the plurality of motors; and selectively actuate the plurality of motors based on the determined angle and the one or more copedant settings to adjust a pitch of a plurality of strings of an instrument.

In some embodiments, each of the one or more pedal arrangements comprises a pedal coupled at the second portion of the frame and configured to be actuated by a user. Further, a first linkage unit coupled at the first portion of the frame. Further, a connecting rod operatively linked to the pedal at one end and the first linkage unit at another end, wherein the actuation of the pedal causes the connecting rod to move in a linear direction movement. In some embodiments, the first linkage unit is configured to convert the linear direction movement into a rotational direction movement.

In some embodiments, each of the one or more lever arrangements comprises a lever coupled at the first portion of the frame and configured to be actuated along a lateral direction movement and vertical direction movement. Further, a second linkage unit coupled at the first portion of the frame and operatively linked to the lever. In some embodiments, the second linkage unit is configured to convert the lateral direction movement and the vertical direction movement into a rotational direction movement. In some embodiments, the one or more sensors corresponds to at least one of a potentiometer sensor, a gyroscope sensor, or an accelerometer sensor.

In some embodiments, the at least one mounting chassis further comprises a plurality of mounting holes sequentially placed along a length of the at least one mounting chassis and each of the plurality of mounting holes is configured to rigidly mount corresponding motor of the plurality of motors. Further, a plurality of fastening holes fabricated proximately to each of the plurality of mounting holes, wherein the plurality of fastening holes is configured to fasten the corresponding motor with the corresponding mounting hole of the plurality of mounting holes. In some embodiments, each of the plurality of mounting holes are positioned such that each mounting hole is offset to each other and disposed at a predefined distance along the length of the at least one mounting chassis.

In some embodiments, the system further comprises a plurality of pull rods coupled at the first portion of the frame, wherein one end of each of the plurality of pull rods is coupled to the corresponding motor of the plurality of motors and other end of each of the plurality of pull rods is coupled to a pitch changing device, wherein the actuation of the motor of the plurality of motors facilitates to pull or push the corresponding pull rod of the plurality of pull rods to enable the pitch changing device to increase or decrease the pitch of the plurality of strings by changing pitch settings. In some embodiments, the plurality of motors corresponds to at least a servomotor, a stepper motor or a linear actuator, wherein each of the motor and the corresponding pull rod is connected to a corresponding string of the plurality of strings. In some embodiments, the one or more copedant settings are received from at least input unit, wherein the at least one input unit corresponds to at least one of a bar holder or at least one user device.

In some embodiments, the bar holder is communicatively coupled to the at least one microcontroller, the bar holder comprises a holder equipped by a user, a tone bar coupled to the holder at a first portion of the holder; and a joystick coupled to the holder at a second portion of the holder and configured to be rotated by the user in a plurality of directions. In some embodiments, each direction of the plurality of directions is pre-coded with at least one of the one or more copedant settings. In some embodiments, the at least one user device is installed with an interface module, wherein the interface module corresponds to a copedant editor table, wherein the copedant editor table enables the user to adjust the copedant settings and create one or more profiles having an individual copedant settings.

In some embodiments, the one or more copedant settings comprises at least one of information corresponding to selective connection of the one or more pedal arrangements and the one or more lever arrangements with the plurality of strings via the corresponding motor and the corresponding pull rod, and the pitch settings, wherein the pitch setting defines a degree of rotation of the plurality of motors corresponding to combination of the movement of the one or more pedal arrangements and the one or more lever arrangements.

In some embodiments, a bar holder is disclosed. The bar holder comprising a holder equipped by a user. The bar holder further comprising a tone bar coupled to the holder at a first portion of the holder. Further, a joystick coupled to the holder at a second portion of the holder and configured to be rotated by the user in a plurality of directions, wherein each direction of the plurality of directions is pre-coded with at least one of one or more copedant settings of a musical instrument.

In some embodiments, the bar holder is configured to allow the user to select at least one of the one or more of copedant settings by rotating the joystick in at least one of the plurality of directions.

In some embodiments, the copedant setting comprises information corresponding to selective connection of one or more pedal arrangements and one or more lever arrangements with a plurality of strings of the musical instrument via a corresponding motor and a corresponding pull rod, and pitch settings for the plurality of strings.

In some embodiments, a method is disclosed. The method comprises steps of receiving, via at least one microcontroller communicatively coupled to each of one or more sensors and each of a plurality of motors of at least one mounting chassis installed at a first portion of a frame, one or more signals from each of the one or more sensors and a plurality of copedant settings, wherein the one or more sensors are communicatively coupled to one or more pedal arrangements installed at the first portion and a second portion of the frame and one or more lever arrangements installed at one or more positions of the first portion of the frame, wherein the one or more sensors are configured to output the one or more signals indicative of a movement of the one or more pedal arrangements and the one or more lever arrangements; determining, via the at least one microcontroller, an angle based on the received one or more signals, wherein the angle corresponds to an amount of rotational movement of the plurality of motors; and actuating, via the at least one microcontroller, selectively the plurality of motors based on the determined angle and the one or more copedant settings to adjust a pitch of a plurality of strings of an instrument.

### BRIEF DESCRIPTION OF THE DRAWINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

FIG. 1 illustrates a front view of a frame of a system in accordance with an example embodiment of the present invention;

FIGS. 2A-2B illustrate a perspective view of a lever arrangement of one or more lever arrangements in accordance with an example embodiment of the present invention;

FIG. 3A illustrates an isometric view of at least one mounting chassis in accordance with an example embodiment of the present invention;

FIG. 3B illustrates a perspective view of at least one mounting chassis installed with the frame in accordance with an example embodiment of the present invention;

FIG. 3C illustrates coupling of a plurality of motors with the at least one mounting chassis in accordance with an example embodiment of the present invention.

FIG. 4A illustrates a perspective view of at least one screw shield installed along with the frame in accordance with an example embodiment of the present invention;

FIG. 4B illustrates a block diagram showing one or more sensors communicatively coupled to at least one microcontroller which is further communicatively coupled to a plurality of motors in accordance with an example embodiment of the present invention;

FIGS. 5A-5B illustrate a perspective view of a bar holder equipped over a hand of a user in accordance with an example embodiment of the present invention;

FIG. 5C illustrates a perspective view of the bar holder in accordance with an example embodiment of the present invention;

FIGS. 6A-6B illustrate an interface module of at least one user device in accordance with an example embodiment of the present invention;

FIG. 7 illustrates a flowchart showing a method for communication between the at least one microcontroller and the at least one user device in accordance with an example embodiment of the present invention;

FIG. 8 illustrates a flowchart showing a method for adjusting one or more copedant settings of an instrument via the at least one user device in accordance with an example embodiment of the present invention; and

FIG. 9 illustrates a flowchart showing a method for adjusting pitch of a plurality of strings of the instrument in accordance with an example embodiment of the present invention.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems, and methods are now described.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

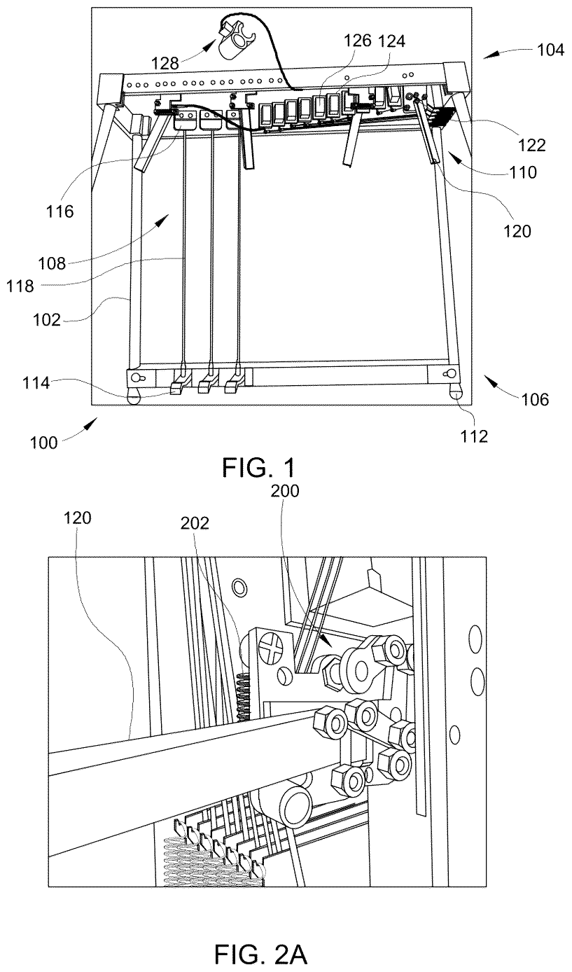

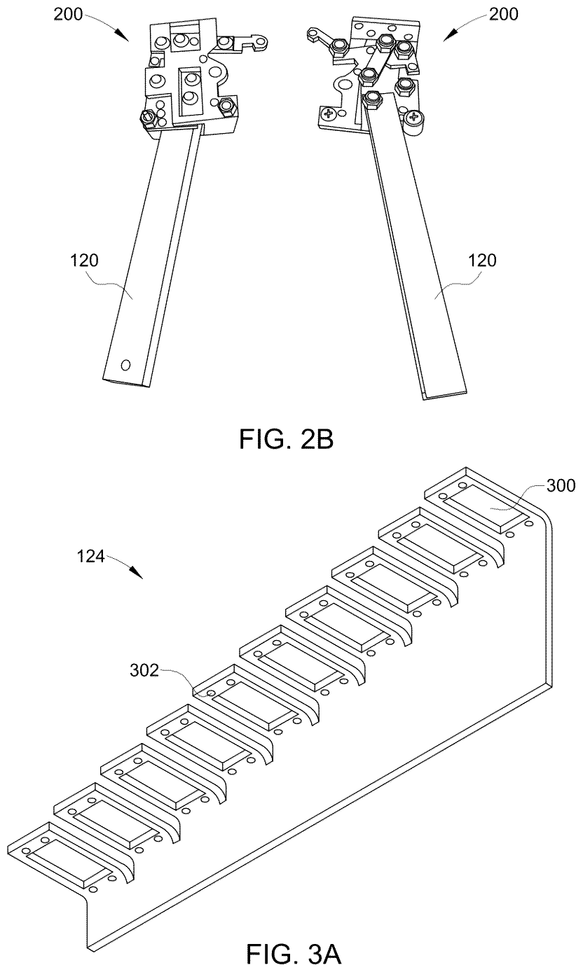

FIG. 1 illustrates a front view of a frame 102 of a system 100, in accordance with an example embodiment of the present invention. FIGS. 2A-2B illustrate a perspective view of a lever arrangement of one or more lever arrangements 110, in accordance with an example embodiment of the present invention.

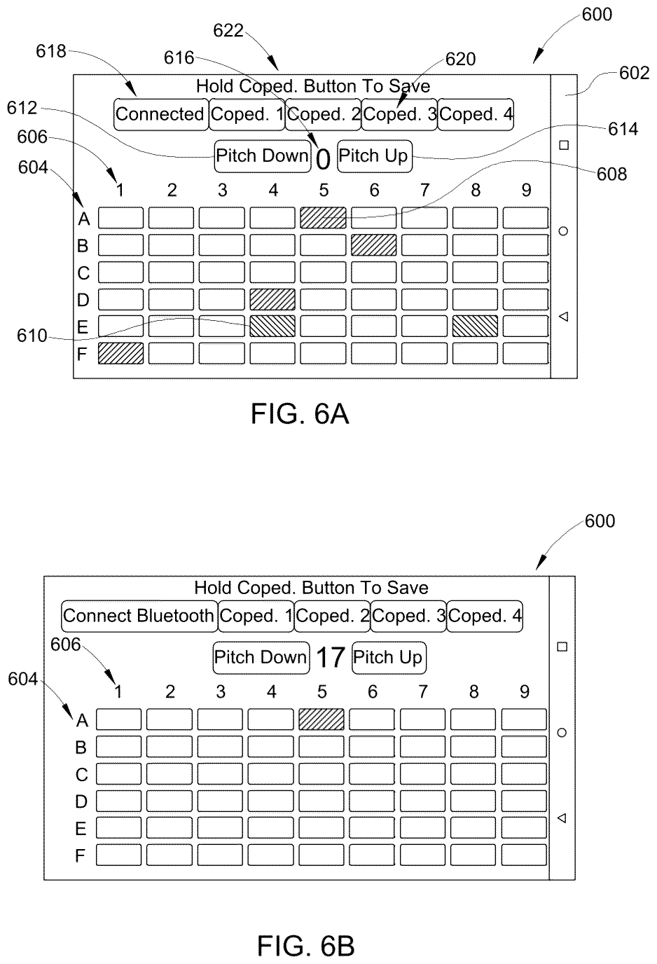

In some embodiments, the system 100 corresponds to a musical instrument control system or a musical instrument system. In some embodiments, the system 100 comprises the frame 102, one or more pedal arrangements 108, the one or more lever arrangements 110, one or more sensors (shown in FIG. 2A), at least one mounting chassis 124 installed with a plurality of motors 126, and at least one microcontroller (not shown). Further, the system 100 comprises at least one input unit that corresponds to at least one bar holder 126 and at least one user device (as shown in FIGS. 6A and 6B).

In some embodiments, the frame 102 is specifically designed to enhance stability, portability, and acoustic performance of an instrument while supporting intricate mechanical elements of the instrument. The frame 102 may be constructed from lightweight and durable materials such as an aluminium alloy, a carbon fiber, or a reinforced wood. Such materials are carefully selected to ensure minimal vibration damping, providing optimal tonal resonance, and durability during prolonged use.

In some embodiments, the frame 102 comprises a modular design, allowing for easy assembly and disassembly without compromising structural integrity. In one example, the frame 102 may comprise plurality of detachable legs 112 and crossbars (not shown) that allow the frame 102 to be highly portable, catering to the needs of musicians who frequently transport the instrument. The frame 102 may further comprise reinforced joints and non-slip feet. The reinforced joints ensures a secure platform during play of the instrument, even under the dynamic conditions created by engaging multiple pedals and knee levers simultaneously.

In some embodiments, the frame 102 may comprise a first portion 104 and a second portion 106. The first portion 104 corresponds to a top portion of the frame 102 and the second portion 106 corresponds to a bottom portion of the frame 102. In some embodiments, the system 100 further comprises the one or more pedal arrangements 108 installed at the first portion 104 and the second portion 106 of the frame 102. In some embodiments, each of the one or more pedal arrangements 108 may comprise a pedal 114, a first linkage unit 116, and a connecting rod 118.

In some embodiments, the pedal 114 is coupled at the second portion 106 of the frame 102. In some embodiments, the pedal 114 is configured to be actuated by the user by pressing the pedal 114. In some embodiments, the pedal 114 is a foot-operated component designed to provide a comfortable and stable interface for the user. In some embodiments, the pedal 114 is made from durable materials such as aluminium or reinforced steel. In some embodiments, the pedal 114 comprises a robust yet lightweight construction to withstand frequent use without compromising the user's comfort. The pedal 114 may be contoured and textured to prevent slippage, ensuring secure foot placement during operation.

The pedal 114 is configured to have an ergonomic design to accommodate a range of foot sizes and playing styles, reducing fatigue during extended sessions. In some embodiments, the pedal 114 is mounted on a pivoting mechanism (not shown) that allows the user to press the pedal 114 in a smooth and precise movement. The positioning of the pedal 114 on the frame 102 is optimized to ensure easy access while maintaining natural alignment of the user's leg and foot for enhanced comfort and performance.

In some embodiments, the first linkage unit 116 is further coupled at the first portion 104 of the frame 102. Further, the connecting rod 118 is operatively linked to the pedal 114 at one end and the first linkage unit 116 at another end. In some embodiments, the actuation of the pedal 114 causes the connecting rod 118 to move in a linear direction movement i.e., linear motion. Further, in some embodiments, the first linkage unit 116 is configured to convert the linear direction movement into a rotational direction movement i.e., rotational motion.

In some embodiments, the first linkage unit 116 is a mechanical assembly designed to transform the linear motion of the connecting rod 118 into the rotational motion. In some embodiments, the first linkage unit 116 is composed of a series of interconnected linkages and joints (not shown), each contributing to the precise conversion of motion. The internal workings of the first linkage unit 116 involve the linkages and joints, arranged in a sequential mechanism to ensure efficient and smooth operation.

In some embodiments, when the connecting rod 118 is actuated by the pedal 114, then the connecting rod 118 exerts a linear force on the first linkage unit 116. This force is transferred through the linkages and joints, which are strategically positioned to facilitate controlled movement. The first linkage unit 116 redirects the linear input into an angular motion. In some embodiments, the first linkage unit 116 comprises low-friction bearings or bushings (not shown) to reduce resistance and wear. The low-friction bearings ensure that the energy from the connecting rod 118 is efficiently transferred to as the rotational movement.

In some embodiments, each of the one or more lever arrangements 110 comprises a lever 120 and a second linkage unit 122. In some embodiments, the lever 120 is coupled at the first portion 104 of the frame 102. In some embodiments, the lever 120 is configured to be actuated along a lateral direction movement and a vertical direction movement. In some embodiments, the lever 120 is a mechanical component designed to adjust the pitch of specific strings of the instrument by altering tension. The lever 120 is positioned to be engaged by the user's knee while seated, allowing for hands-free operation in conjunction with the pedal 114.

In some embodiments, the lever 120 is constructed from durable materials, such as aluminium or steel, to ensure longevity and withstand repeated use. The ergonomic design of the lever 120 ensures smooth and comfortable operation. The lever 120 is positioned at an angle and distance that allows for natural movement of the user's leg, minimizing strain during extended play. Further, the second linkage unit 122 is coupled at the first portion 104 of the frame 102 and operatively linked to the lever 120 (as shown in FIGS. 2A and 2B). In some embodiments, similar to the first linkage unit 116, the second linkage unit 122 is configured to convert the lateral direction movement and the vertical direction movement of the lever 120 into a rotational direction movement.

In some embodiments, the second linkage unit 122 is a mechanical assembly designed to transform the lateral motion and vertical motion of the lever 120 into the rotational motion. In some embodiments, the second linkage unit 122 is composed of a series of interconnected linkages and joints 200, each contributing to the precise conversion of motion. The internal workings of the second linkage unit 122 involve multiple articulated linkages and joints 200 and a spring 202 that are arranged in a sequential mechanism to ensure efficient and smooth operation. In some embodiments, the vertical motion of the lever 120 is achieved when knee of the user is lifted vertically. The vertical motion his is done by rotating the lever 120 parallel with the floor and tighten in place. This may add two additional knee lever possibilities to be operated by raising the knee vertically.

In some embodiments, when the lever 120 is actuated, then the lever 120 exerts a lateral force and vertical force on the second linkage unit 122. This force is transferred through interconnected linkages and joints 200 which are strategically positioned to facilitate controlled movement. The interconnected linkages and joints 200 redirects the linear input into an angular motion. This angular motion is then transferred to the subsequent linkages in the assembly. In some embodiments, the second linkage unit 122 comprises low-friction bearings or bushings (not shown) to reduce resistance and wear. The low-friction bearings ensure that the energy from the lever 120 is efficiently transferred to as the rotational movement.

In some embodiments, the one or more sensors are communicatively coupled to the one or more pedal arrangements 108 and the one or more lever arrangements 110. In some embodiments, the one or more sensors are configured to output one or more signals. In some embodiments, the one or more signals are indicative of the rotational movement of the first linkage unit 116 and the second linkage unit 122. In some embodiments, the one or more sensors corresponds to at least one of a potentiometer sensor or an accelerometer sensor. In some embodiments, the one or more sensors may also correspond to a gyroscope sensor.

In one example embodiments, the potentiometer sensor works by converting an angular displacement or the rotational movement of the first linkage unit 116 and the second linkage unit 122 into a corresponding electrical signal. The potentiometer sensor consists of a resistive track (not shown) and a wiper (not shown) that moves along the track as a shaft of the potentiometer sensor connected to the first linkage unit 116 and the second linkage unit 122 rotates. As the wiper shifts position, the wiper changes the resistance between the wiper and fixed terminals at each end of a resistive element. This variation in resistance produces a voltage at the output terminal, which is directly proportional to the angle of rotation.

It will be apparent to one skilled in the art that above-mentioned components of the system 100 have been provided only for illustration purposes, without departing from the scope of the disclosure.

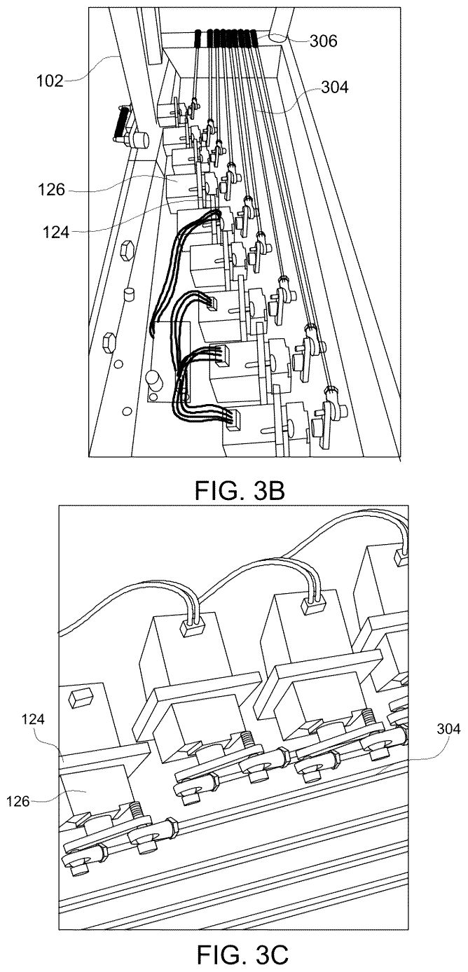

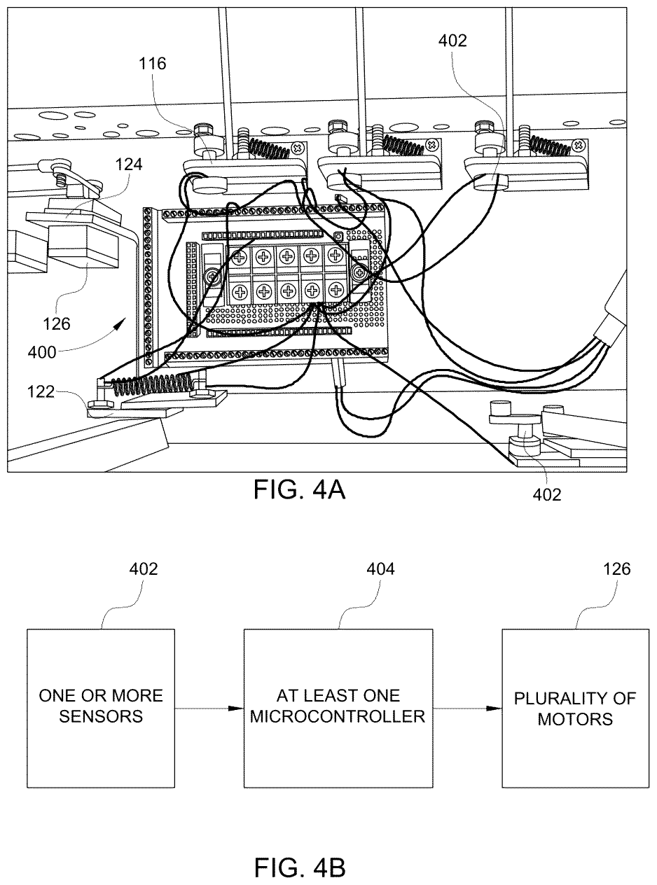

FIG. 3A illustrates an isometric view of the at least one mounting chassis 124, in accordance with an example embodiment of the present invention. FIG. 3B illustrates a perspective view of the at least one mounting chassis 124 installed with the frame 102, in accordance with an example embodiment of the present invention. FIG. 3C illustrates coupling of the plurality of motors 126 with the at least one mounting chassis 124, in accordance with an example embodiment of the present invention. FIG. 4A illustrates a perspective view of at least one screw shield 400 installed along with the frame 102, in accordance with an example embodiment of the present invention. FIG. 4B illustrates a block diagram showing one or more sensors 402 communicatively coupled to at least one microcontroller 404 which is further communicatively coupled to a plurality of motors 126, in accordance with an example embodiment of the present invention.

In some embodiments, the frame 102 further comprises the at least one mounting chassis 124 installed with the plurality of motors 126. In some embodiments, the at least one mounting chassis 124 is installed at the first portion 104 of the frame 102. In one example embodiment, the at least one mounting chassis 124 may be made of aluminium. In another example embodiment, the at least one mounting chassis 124 may be fabricated by using a 3D printed plastics. In some embodiments, the at least one mounting chassis 124 comprises a plurality of mounting holes 300 and a plurality of fastening holes 302.

In some embodiments, the plurality of mounting holes 300 are configured to be sequentially placed along a length of the at least one mounting chassis 124. In some embodiments, each of the plurality of mounting holes 300 is configured to rigidly mount corresponding motor of the plurality of motors 126 with the at least one mounting chassis 124. Further, the plurality of fastening holes 302 is fabricated proximately to each of the plurality of mounting holes 300. In some embodiments, the plurality of fastening holes 302 is configured to fasten the corresponding motor with the corresponding mounting hole of the plurality of mounting holes 300. In some embodiments, each of the plurality of mounting holes 300 are positioned such that each mounting hole is offset to each other and disposed at a predefined distance along the length of the at least one mounting chassis 124. In one example embodiment, the predefine distance is 8 mm from each other.

In some embodiments, the frame 102 further comprises a plurality of pull rods 304 coupled at the first portion 104 of the frame 102. In some embodiments, one end of each of the plurality of pull rods 304 is coupled to the corresponding motor of the plurality of motors 126 and other end of each of the plurality of pull rods 304 is coupled to a pitch changing device 306. In some embodiments, the actuation of the motor of the plurality of motors 126 facilitates to pull or push the corresponding pull rod of the plurality of pull rods 304 to enable the pitch changing device 306 to increase or decrease the pitch of the plurality of strings. In some embodiments, the pitch changing device 306 may be implemented within the system 100 or outside the system 100.

In some embodiments, the plurality of mounting holes 300 are designed to orient the plurality of motors 126 offset from the predefined distance from each other. In some embodiments, the predefined distance of offset is equal to a pull rod hole spacing (not shown) of the pitch changing device 306. In some embodiments, the predefined distance of the offset keeps the plurality of pull rods 304 parallel, organized, and in alignment with the pull rod hole spacing of the pitch changing device 306. In one example embodiments, the pitch changing device 306 may have 20 attachment points which allows copedant of the instrument to be fully edited. In some embodiments, the plurality of motors 126 corresponds to a servomotor. In another embodiment, the plurality of motors 126 correspond to at least a stepper motor or linear actuator. In some embodiments, the stepper motor is configured to give precise positional feed to the corresponding pull rod based on the input. In some embodiments, each of the motor and the corresponding pull rod is connected to a corresponding string of the plurality of strings via the pitch changing device 306.

In some embodiments, the at least one screw shield 400 is configured to attach wires among the one or more sensors 402, the at least one microcontroller 404, and each of the plurality of motors 126. In some embodiments, the at least one microcontroller 404 may be positioned underneath the at least one screw shield 400. In some embodiments, the at least one microcontroller is configured to receive the one or more signals from each of the one or more sensors and one or more copedant settings. In some embodiments, the one or more signals are indicative of the rotational movement of the first linkage unit 116 and the second linkage unit 122 from the one or more pedal arrangements 108 and the one or more lever arrangements 110, respectively.

Further, the at least one microcontroller is configured to determine an angle based on the received one or more signals. In some embodiments, the angle corresponds to an amount of rotational movement of the plurality of motors 126. Further, the at least one microcontroller is configured to selectively actuate the plurality of motors 126 based on the determined angle and the one or more copedant settings to adjust a pitch of the plurality of strings of the instrument. In some embodiments, the one or more copedant settings are received from the at least one user device (as shown in FIGS. 6A and 6B). The motion of the plurality of motors 126 may be made visible to give visual feedback of which strings of the plurality of strings are being manipulated. In some embodiments, an onboard screen (not shown) may be installed or a mobile application for configuration of the one or more copedant settings.

In some embodiments, the at least one microcontroller is configured for executing predefined algorithms and managing various inputs and outputs in the described invention. The at least one microcontroller is programmed to receive input signals from the one or more sensors 402 (i.e., the potentiometer sensor, as shown in FIG. 4A), process the data, and generate corresponding output signals to actuate mechanical or electronic components. In some embodiments, the at least one microcontroller 404 is configured to communicatively coupled with the one or more sensors 402 and the plurality of motors 126 as shown in FIG. 4B. In some embodiments, the one or more sensors 402 are connected to the at least one microcontroller 404 to send the input signals as discussed above and further the at least one microcontroller 404 is connected to the plurality of motors 126 to send command signals to actuate the plurality of motors 126. The at least one microcontroller 404 may correspond to any microcontroller known in the art.

The at least one microcontroller 404 features a central processing unit (CPU), a memory for storing instructions and data, and input/output (I/O) interfaces for communication with peripheral devices. Depending on the application, the at least one microcontroller 404 may include integrated modules such as analog-to-digital converters (ADC), timers, pulse-width modulation (PWM) controllers, or communication interfaces like UART, I2C, or SPI. The programmability and versatility of the at least one microcontroller 404 may enable efficient and precise operation, adapting the functionality of the system 100 to specific user inputs, environmental conditions, or real-time feedback from connected components.

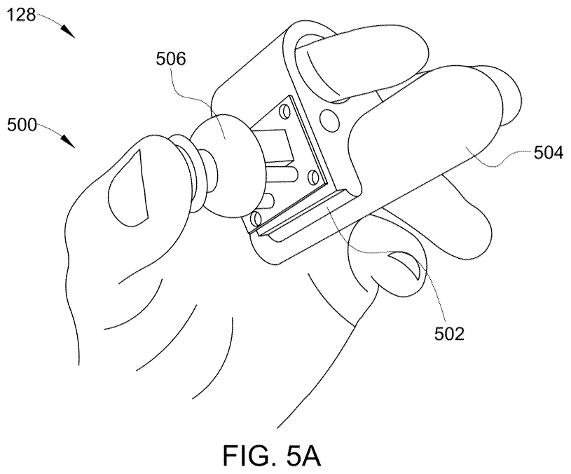

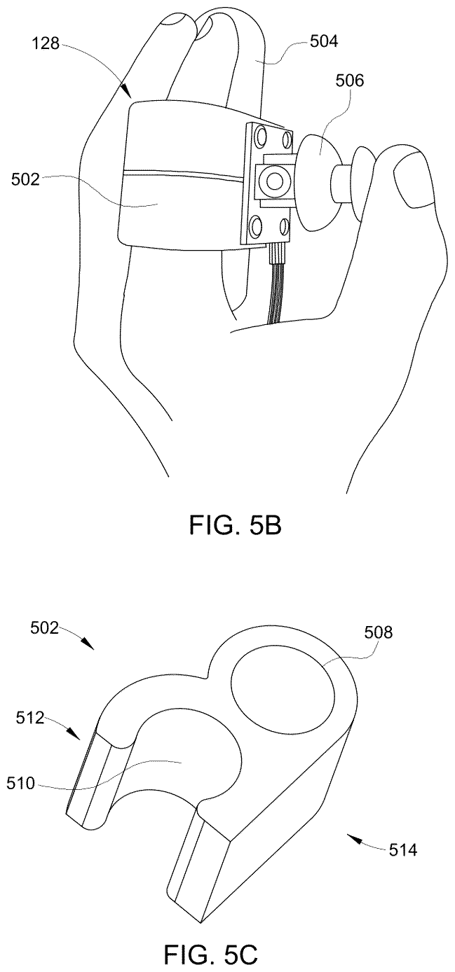

FIGS. 5A-5B illustrate a perspective view of a bar holder 128 equipped over a hand 500 of the user, in accordance with an example embodiment of the present invention. FIG. 5C illustrates a perspective view of the bar holder 128, in accordance with an example embodiment of the present invention.

In some embodiments, the bar holder 128 is communicatively coupled to the at least one microcontroller 404. The bar holder 128 comprises a holder 502, a tone bar 504, and a joystick 506. In some embodiments, the holder 502 is equipped by the user over the hand 500. In some embodiments, the holder 502 comprises a first aperture 508 and a second aperture 510. The first aperture 508 is configured to insert a finger of the user and the second aperture 510 is fabricated at a first portion 512 of the bar holder 128 and is configured to position the tone bar 504. In some embodiments, the bar holder 128 may enable the user to play the instrument by being standing in addition to a traditional seated configuration.

In some embodiments, the tone bar 504 enables the user to produce smooth, gliding tones and precise pitch modulation. In some embodiments, the tone bar 504 is pressed against the plurality of strings and slide along a fretboard as the user adjusts vibrating length of the plurality of strings to create different pitches. In one example embodiments, the tone bar 504 is made of stainless steel or chrome-plated brass, to enhance sustain and tonal clarity. The tone bar 504 allows for seamless transitions between notes, expressive vibrato by rocking the tone bar 504 gently, and the execution of complex chords or harmonics by pressing multiple strings simultaneously.

In some embodiments, the bar holder 128 further comprises the joystick 506 coupled at a second portion 514 of the tone bar 504. In some embodiments, the joystick 506 is configured to be rotated by the user in a plurality of directions such as each direction of the plurality of directions is pre-coded with a least one of the one or more copedant settings. The one or more copedant settings comprises at least one of information corresponding to selective connection of the one or more pedal arrangements 108 and the one or more lever arrangements 110 with the plurality of strings via the corresponding motor and the corresponding pull rod, and the pitch setting. The pitch setting defines a degree of rotation of the plurality of motors 126 corresponding to the movement of the one or more pedal arrangements 108 and the one or more lever arrangements 110.

The pitch setting for an affected string is saved based on the combination of the one or more pedal arrangements 108. One string may have multiple pitch settings accessed by different combinations of the one or more lever arrangements 110. In one example, pressing a first pedal “A” and a second lever “F” may lower string 5 by a value of 25 and raise string 6 by a value of 30. Pressing a third pedal “C” and a third lever “G” may lower string 5 by a value 30 instead and raise string 9 by a value of 12.

The pitch setting for an affected string is saved based on the combination of pedals, and not the string specifically. One string may have multiple pitch settings accessed by different combinations of levers which is called as “split tuning”. The split tunning is done to correct mechanical changes that occur when forces in the body of the instrument change. This change is due to a wide array of variables related to the nature of musical harmonics, varying string sizes, and more. It is intentional to allow the user to have multiple pitch settings available per string.

FIGS. 6A-6B illustrate an interface module 600 of the at least one user device 602, in accordance with an example embodiment of the present invention.

In some embodiments, the interface module 600 corresponds to a copedant editor table installed within the at least one user device 602. In some embodiments, the copedant editor table comprises a column 604 having a list of the pedal of the one or more pedal arrangements 108, lever of the one or more lever arrangements 110, and a list of the plurality of directions of the joystick 506. In some embodiments, the list of the pedal of the one or more pedal arrangements 108 comprises A, B, C, D, E, F, 1, 2, 3, and 4.

In some embodiments, “A” represents a first pedal of the plurality of pedal arrangements 108, “B” represents a second pedal of the plurality of pedal arrangements 108, “C” represents a third pedal of the plurality of pedal arrangements 108, “D” represents a fourth pedal of the plurality of pedal arrangements 108, “E” represents a first lever of the one or more lever arrangements 110, “F” represents a second lever of the one or more lever arrangements 110, “G” represents a third lever of the one or more lever arrangements 110, “H” represents a fourth lever of the one or more lever arrangements 110, “1” represents a first direction movement of the joystick 506, “2” represents a second direction movement of the joystick 506, “3” represents a third direction movement of the joystick 506, and “4” represents a fourth direction movement of the joystick 506.

In some embodiments, the copedant editor table comprises a row 606 having a list of numerals 1, 2, 3, 4, 5, 6, 7, 8, 9, and 10 where each numeral representing each string of the plurality of strings. Further, the copedant editor table comprises a grid having a plurality of boxes. In some embodiments, each box of the plurality of boxes corresponds to a correlation of a corresponding lever, pedal, or direction of the joystick 506 with a corresponding string of the plurality of strings. In one example, upon tapping on a box 608, the user is able to adjust pitch of the string “5” connected to the lever “A”. Similarly, upon tapping on a box 610, the user is able to adjust pitch of the string “4” connected with the lever “E”. Further, the copedant editor table comprises a pitch down button 612, a pitch up button 614 and an indicator 616. The pitch down button 612 is configured to decrease pitch of the selected string, the pitch up button 614 is configured to increase pitch of the selected string and the indicator 616 is configured to display level of pitch of the selected string to the user.

In one example, the indicator 616 in FIG. 6B shows value “17” as shown in (FIG. 6B) while the box 608 is selected. The value “17” represents that the string “5” connected to the lever “A” is adjusted with increased pitch “17”. In another example, the value “−17” may represent that the string “5” is adjusted with decreased pitch “−17”. In some embodiments, the copedant editor table comprises a connection status indicator 618 that is configured to indicate to the user whether the at least one user device 602 is connected to the at least one microcontroller 404 or not. In some embodiments, the connection status indicator 618 indicating “CONNECTED” indicates that the at least one user device 602 is connected with the at least one microcontroller 404 wirelessly or wired and the connection status indicator 618 indicating “NOT CONNECTED” indicates that the at least one user device 602 is not connected with the at least one microcontroller 404.

Further, the copedant editor table comprises copedant setting profiles 620. The copedant editor table enables the user to save multiple of the copedant setting profiles 620. In some embodiments, each profile of the copedant setting profiles 620 comprises at least one of information corresponding to selective connection of the one or more pedal arrangements 108 and the one or more lever arrangements 110 with the plurality of strings via the corresponding motor and the corresponding pull rod, and the pitch setting. In some embodiments, upon tapping of one of the copedant setting profile i.e. “Coped 1”, the copedant editor table is populated with all the strings with the adjustment of the pitch either marked with “Green” or “Red”. The “Green” marking represents the pitch of the corresponding string is greater than 0 and “Red” represents the pitch of the corresponding string is lower than 0. Further, the copedant editor table comprises instruction indicator 622 showing instruction “HOLD COPED. BUTTON TO SAVE” that instructs the user to long press any one of the copedant setting profiles 620 to save changes done by the user.

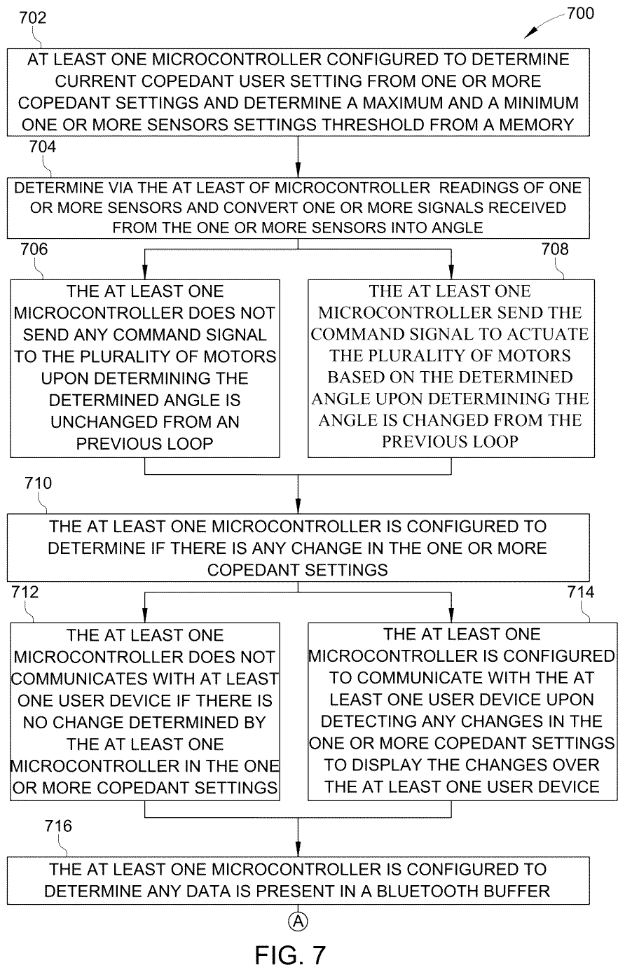

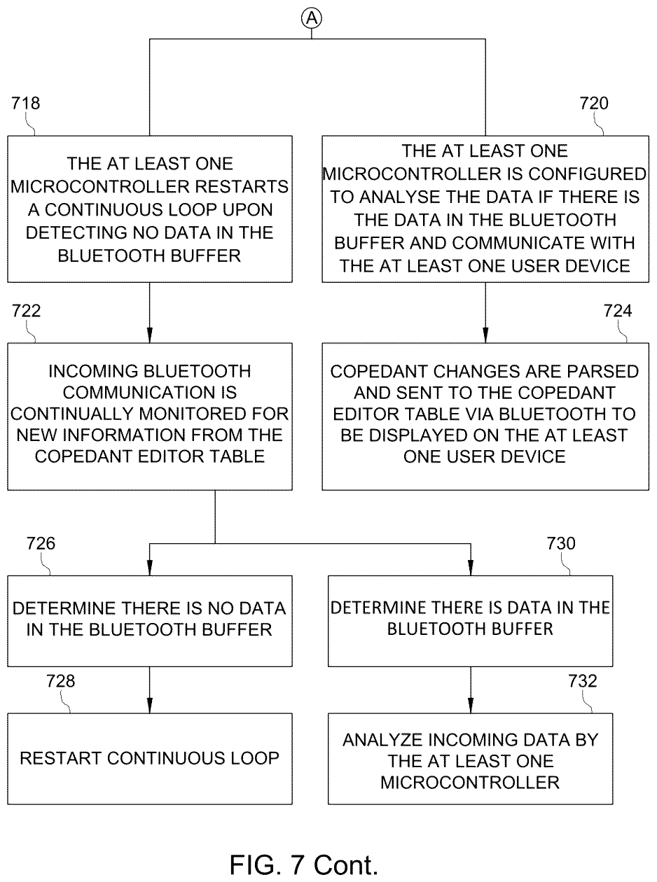

FIG. 7 illustrates a flowchart showing a method 700 for communication between the at least one microcontroller 404 and the at least one user device 602, in accordance with an example embodiment of the present invention.

Firstly at step 702, the at least one microcontroller 404 is configured to determine current copedant user setting from the one or more copedant settings and determine a maximum and a minimum one or more sensor settings threshold from the memory. In some embodiments, the at least one microcontroller 404 positions the plurality of motors 126 in a neutral position based on the determined maximum and minimum one or more sensor settings threshold. Successively, at step 704, the at least one microcontroller 404 is configured to determine readings of the one or more sensors 402 and convert the one or more signals received from the one or more sensors 402 into angles. Successively, at step 706, the at least one microcontroller 404 does not send any command signal to the plurality of motors 126 upon determining the determined angle is unchanged from the previous loop.

Alternatively to step 706, at step 708, the at least one microcontroller 404 sends the command signal to actuate the plurality of motors 126 based on the determined angle upon determining the determining angle is unchanged from the previous loop. In some embodiments, the actuation of the plurality of motors 126 facilities to adjust the pitch of the plurality of strings. Successively, at step 710, the at least one microcontroller 404 is configured to determine if there is any change in the one or more copedant settings. Successively, at step 712, the at least one microcontroller 404 does not communicate with the at least one user device 602 if there is no change determined by the at least one microcontroller 404 in the one or more copedant settings. Alternatively, at step 714, the at least one microcontroller 404 is configured to communicate with the at least one user device 602 upon detecting any change in the one or more copedant settings to display the changes over the at least one user device 602.

Successively, at step 716, the at least one microcontroller 404 is configured to determine any data is present in a Bluetooth buffer. Successively, at step 718, the at least one microcontroller 404 restarts a continuous loop upon detecting that there is no data in the Bluetooth buffer. Successively, at step 720, the at least one microcontroller 404 is configured to analyse the data if there is the data in the Bluetooth buffer and communicate with the at least one user device 602.

Successively, at step 722, the at least one microcontroller 404 is configured to continuously monitor an incoming Bluetooth communication for new information from the copedant editor table. Successively, at step 724, changes to the one or more copedant settings are parsed and sent to the copedant editor table via Bluetooth to be displayed on the at least one user device 602. Successively, at step 726, the at least one microcontroller 404 is configured to determine if there is no data in the Bluetooth buffer. Successively, at step 728, the at least one microcontroller 404 restarts continuous loop. Alternatively to step 726, at step 730, the at least one microcontroller 404 is configured to determine if there is data in the Bluetooth buffer. Successively, at step 732, the at least one microcontroller 404 is configured to analyse the received data upon determining Bluetooth buffer.

In some embodiments, if incoming data has a “c” prefix, then the incoming data is the copedant row & column of an active copedant (user profile) selected by the user. The stored value in that location is sent via Bluetooth to the at least one user device 602 to be displayed to the user. Alternatively, if the incoming data has a “u” prefix, then it corresponds to add 1 to a location of the active copedant selected by the user to reach the desired pitch change. Further, if incoming data has a “d” prefix, then subtract 1 to the location of the active copedant selected by the user to reach the desired pitch change. Further, if incoming data has q, w, e, or r prefix, then access copedant 1, 2, 3, or 4 settings in the memory and set as the active copedant setting. Further, if the incoming data has t, y, I, or o prefix, then save the active copedant setting to copedant 1, 2, 3, or 4 settings in the memory. Further, if the incoming data has a “s” prefix, then save the active copedant settings and all current copedant settings to the memory.

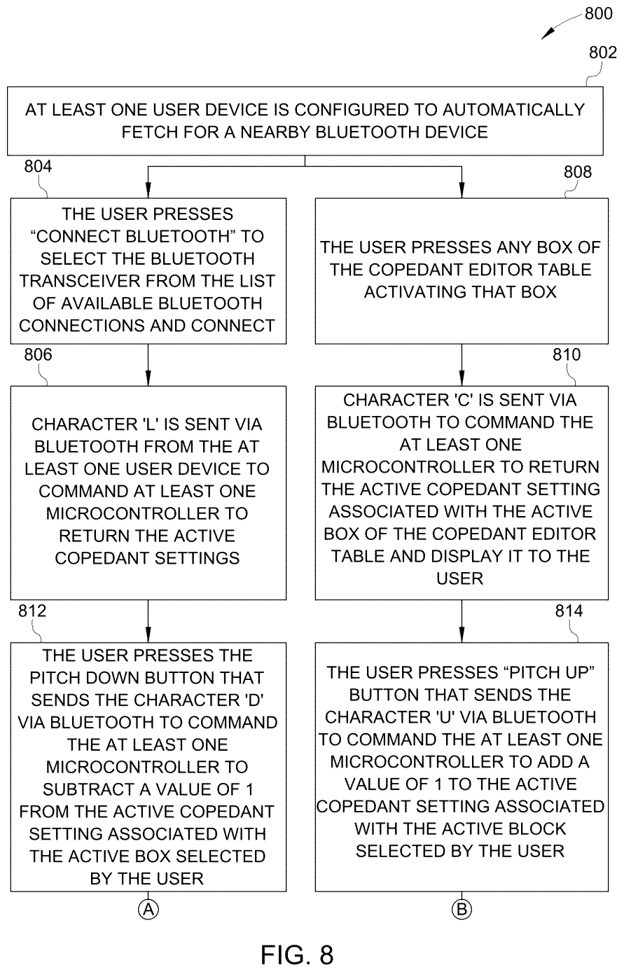

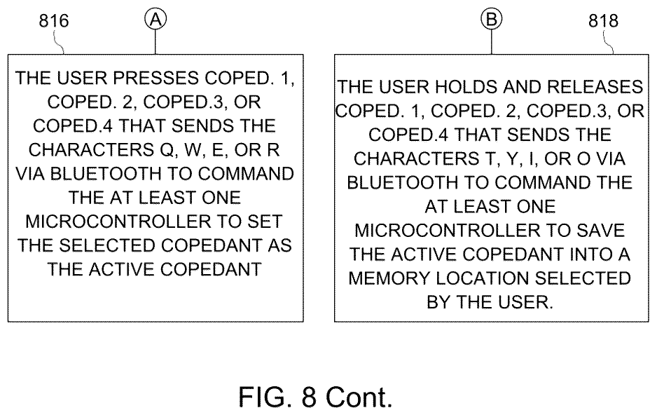

FIG. 8 illustrates a flowchart showing a method 800 for adjusting one or more copedant settings of the instrument via the at least one user device 602, in accordance with an example embodiment of the present invention.

At step 802, the at least one user device 602 is configured to automatically fetch for a nearby Bluetooth device. At step 804, the user presses “Connect Bluetooth” to select the Bluetooth transceiver from the list of available Bluetooth connections and connect. At step 806, the character ‘L’ is sent via Bluetooth from the at least one user device 602 to command the at least one microcontroller 404 to return the active copedant settings. The copedant editor table is then populated to display the active copedant to the user. Successively, at step 808, the user presses any box of the copedant editor table activating that box. Successively, at step 810, the character ‘c’ is sent via Bluetooth to command the at least one microcontroller 404 to return the active copedant setting associated with the active box of the copedant editor table and display it to the user.

Successively, at step 812, the user presses the pitch down button 612 that sends the character ‘d’ via Bluetooth to command the at least one microcontroller 404 to subtract a value of 1 from the active copedant setting associated with the active box selected by the user. Alternatively, at step 814, the user presses pitch up button 614 that sends the character ‘u’ via Bluetooth to command the at least one microcontroller 404 to add a value of 1 to the active copedant setting associated with the active block selected by the user. It may be noted that term “box” may also refer to term “block” and may be interchangeably used. Successively, at step 816, the user presses Coped. 1, Coped. 2, Coped.3, or Coped.4 that sends the characters q, w, e, or r via Bluetooth to command the at least one microcontroller 404 to set the selected copedant setting as the active copedant setting. The new active copedant setting is then sent to the at least one user device 602 to be displayed. Successively, at step 818, the user holds and releases Coped. 1, Coped. 2, Coped.3, or Coped.4 that sends the characters t, y, i, or o via Bluetooth to command the at least one microcontroller 404 to save the active copedant settings into the memory.

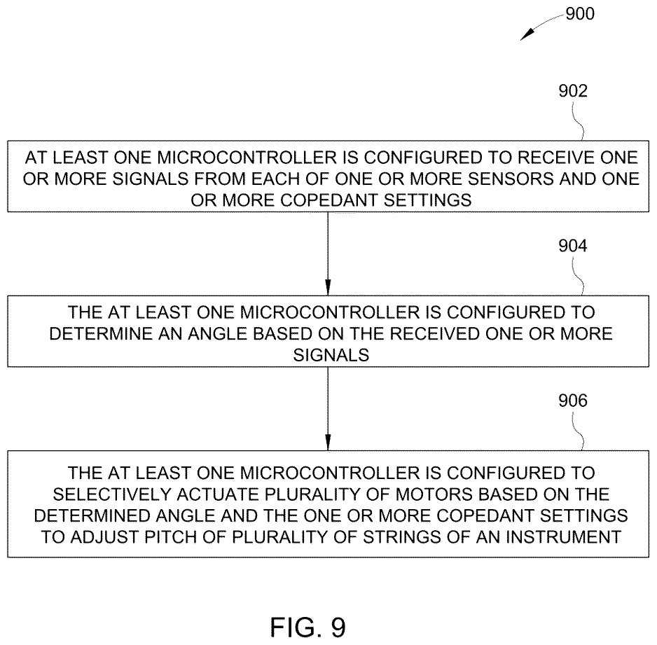

FIG. 9 illustrates a flowchart showing a method 900 for adjusting pitch of the plurality of strings of the instrument, in accordance with an example embodiment of the present invention.

At step 902, the at least one microcontroller 404 is configured to receive the one or more signals from each of the one or more sensors and one or more copedant settings. Successively, at step 904, the at least one microcontroller 404 is configured to determine an angle based on the received one or more signals. The angle corresponds to an amount of rotational movement of the plurality of motors 126. Successively, at step 906, the at least one microcontroller 404 is configured to selectively actuate the plurality of motors 126 based on the determined angle and the one or more copedant settings to adjust the pitch of the plurality of strings of the instrument. In one example embodiment, a plurality of switches (not shown) may be mounted to the instrument that could be used to select copedant (i.e. Chord Pedal Arrangement) settings.

Embodiments of the present invention relate to the system 100 that, upon when executed is configured to edit, save, and recall copedant settings by the musician at their discretion and in which any pedal/lever/input can be assigned to any string to increase or decrease the pitch produced by that string by the musician. Further, the present invention also allows the instrument to be played in a standing position by a user apart from the traditional seated configuration. In some embodiments, the invention discloses about a strategically built chassis integrated with motors for adjusting the pitch of the strings of a musical instrument control system. Further, the invention enables a user to play an instrument of the musical instrument control system, either in traditional seating configuration or standing configuration. Further, in some embodiments, the invention discloses about any pedal/lever/input that can be assigned to any string to increase or decrease the pitch produced by that string. In some embodiments, the invention is configured to electronically sense and observe multiple inputs from the user (in real time) over the pedals and levers of the instrument that may be further amplified, adjusted or saved to enable ease in playing the instrument and improve versatility in playing the instrument. In some embodiments, the invention discloses about saving, editing, and recalling multiple copedant settings of the pedal steel guitar.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

### LIST OF ELEMENTS

100—System
102—Frame
104—First Portion
106—Second Portion
108—One or more pedal arrangements
110—One or more lever arrangements
112—Plurality of Detachable legs
114—Pedal
116—First linkage unit
118—Connecting rod
120—Lever
122—Second linkage unit
124—At least one mounting chassis
126—Plurality of motors
128—bar holder
200—Linkages and joints
202—Spring
300—Plurality of mounting holes
302—Plurality of fastening holes
304—Plurality of pull rods
306—Pitch changing device
400—At least one screw shield
402—One or more sensors
404—At least one microcontroller
502—Holder
504—Tone bar
506—Joystick
508—First aperture
510—Second aperture
512—First portion
514—Second portion
600—Interface module
602—At least one user device
604—Column
606—Row
608—Box
610—Box
612—Pitch down button
614—Pitch up button
616—Indicator
618—Connection status indicator
620—Copedant settings profile
622—Instruction indicator
700—Method
702—Step
704—Step
706—Step
708—Step
710—Step
712—Step
714—Step
716—Step
718—Step
720—Step
722—Step
724—Step
726—Step
728—Step
730—Step
732—Step
800—Method
802—Step
804—Step
806—Step
808—Step
810—Step
812—Step
814—Step
816—Step
818—Step
900—Method
902—Step
904—Step
906—Step

What is claimed is:

1. A system comprising:
a frame having a first portion and a second portion;
one or more pedal arrangements installed at the first portion and the second portion of the frame;
one or more lever arrangements installed at one or more positions of the first portion of the frame;
one or more sensors communicatively coupled to the one or more pedal arrangements and the one or more lever arrangements, wherein the one or more sensors are configured to output one or more signals indicative of a movement of the one or more pedal arrangements and the one or more lever arrangements;
at least one mounting chassis installed at the first portion of the frame and comprising a plurality of motors, wherein each of the plurality of motors are communicatively coupled to each of the one or more sensors;
at least one microcontroller communicatively coupled to each of the one or more sensors and each of the plurality of motors, wherein the at least one microcontroller is configured to:
receive the one or more signals from each of the one or more sensors and one or more copedant settings;
determine an angle based on the received one or more signals, wherein the angle corresponds to an amount of rotational movement of the plurality of motors; and
selectively actuate the plurality of motors based on the determined angle and the one or more copedant settings to adjust a pitch of a plurality of strings of an instrument.

2. The system of claim 1, wherein each of the one or more pedal arrangements comprising:
a pedal coupled at the second portion of the frame and configured to be actuated by a user;
a first linkage unit coupled at the first portion of the frame; and
a connecting rod operatively linked to the pedal at one end and the first linkage unit at another end, wherein the actuation of the pedal causes the connecting rod to move in a linear direction movement, and
wherein the first linkage unit is configured to convert the linear direction movement into a rotational direction movement.

3. The system of claim 1, wherein each of the one or more lever arrangements comprising:
a lever coupled at the first portion of the frame and configured to be actuated along a lateral direction movement and vertical direction movement; and
a second linkage unit coupled at the first portion of the frame and operatively linked to the lever, wherein the second linkage unit is configured to convert the lateral direction movement and the vertical direction movement into a rotational direction movement.

4. The system of claim 1, wherein the one or more sensors corresponds to at least one of a potentiometer sensor, a gyroscope sensor, or an accelerometer sensor.

5. The system of claim 1, wherein the at least one mounting chassis further comprising:
a plurality of mounting holes sequentially placed along a length of the at least one mounting chassis and each of the plurality of mounting holes is configured to rigidly mount corresponding motor of the plurality of motors; and
a plurality of fastening holes fabricated proximately to each of the plurality of mounting holes, wherein the plurality of fastening holes is configured to fasten the corresponding motor with the corresponding mounting hole of the plurality of mounting holes,
wherein each of the plurality of mounting holes are positioned such that each mounting hole is offset to each other and disposed at a predefined distance along the length of the at least one mounting chassis.

6. The system of claim 1, further comprising a plurality of pull rods coupled at the first portion of the frame, wherein one end of each of the plurality of pull rods is coupled to the corresponding motor of the plurality of motors and other end of each of the plurality of pull rods is coupled to a pitch changing device, wherein the actuation of the motor of the plurality of motors facilitates to pull or push the corresponding pull rod of the plurality of pull rods to enable the pitch changing device to increase or decrease the pitch of the plurality of strings by changing pitch settings.

7. The system of claim 6, wherein the plurality of motors corresponds to at least a servomotor, a stepper motor or a linear actuator, wherein each of the motor and the corresponding pull rod is connected to a corresponding string of the plurality of strings.

8. The system of claim 1, wherein the one or more copedant settings are received from at least one input unit, wherein the at least one input unit corresponds to at least one of a bar holder or at least one user device.

9. The system of claim 8, wherein the bar holder is communicatively coupled to the at least one microcontroller, the bar holder comprising:
a holder equipped by a user;
a tone bar coupled to the holder at a first portion of the holder; and
a joystick coupled to the holder at a second portion of the holder and configured to be rotated by the user in a plurality of directions, wherein each direction of the plurality of directions is pre-coded with at least one of the one or more copedant settings.

10. The system of claim 8, wherein the at least one user device is installed with an interface module, wherein the interface module corresponds to a copedant editor table, wherein the copedant editor table enables the user to adjust the copedant settings and create one or more profiles having an individual copedant settings.

11. The system of claim 6, wherein the one or more copedant settings comprises at least one of information corresponding to selective connection of the one or more pedal arrangements and the one or more lever arrangements with the plurality of strings via the corresponding motor and the corresponding pull rod, and the pitch settings, wherein the pitch settings define a degree of rotation of the plurality of motors corresponding to combination of the movement of the one or more pedal arrangements and the one or more lever arrangements.

12. A bar holder comprising:
a holder equipped by a user;
a tone bar coupled to the holder at a first portion of the holder; and
a joystick coupled to the holder at a second portion of the holder and configured to be rotated by the user in a plurality of directions, wherein each direction of the plurality of directions is pre-coded with at least one of one or more copedant settings of an instrument.

13. The bar holder of claim 12, wherein the bar holder is configured to allow the user to select at least one of the one or more of copedant settings by rotating the joystick in at least one of the plurality of directions.

14. The bar holder of claim 12, wherein the copedant setting comprises information corresponding to selective connection of one or more pedal arrangements and one or more lever arrangements with a plurality of strings of the instrument via a corresponding motor and a corresponding pull rod, and pitch settings for the plurality of strings.

15. A method comprising:
receiving, via at least one microcontroller communicatively coupled to each of one or more sensors and each of a plurality of motors of at least one mounting chassis installed at a first portion of a frame, one or more signals from each of the one or more sensors and a plurality of copedant settings, wherein the one or more sensors are communicatively coupled to one or more pedal arrangements installed at the first portion and a second portion of the frame and one or more lever arrangements installed at one or more positions of the first portion of the frame, wherein the one or more sensors are configured to output the one or more signals indicative of a movement of the one or more pedal arrangements and the one or more lever arrangements;
determining, via the at least one microcontroller, an angle based on the received one or more signals, wherein the angle corresponds to an amount of rotational movement of the plurality of motors; and
actuating, via the at least one microcontroller, selectively the plurality of motors based on the determined angle and the one or more copedant settings to adjust a pitch of a plurality of strings of an instrument.

16. The method of claim 15, wherein each of the one or more pedal arrangements comprising:
a pedal coupled at the second portion of the frame and configured to be actuated by a user;
a first linkage unit coupled at the first portion of the frame; and
a connecting rod operatively linked to the pedal at one end and the first linkage unit at another end, wherein the actuation of the pedal causes the connecting rod to move in a linear direction movement, and
wherein the first linkage unit is configured to convert the linear direction movement into a rotational direction movement.

17. The method of claim 15, wherein each of the one or more lever arrangements comprising:
a lever coupled at the first portion of the frame and configured to be actuated along a lateral direction movement and vertical direction movement; and
a second linkage unit coupled at the first portion of the frame and operatively linked to the lever, wherein the second linkage unit is configured to convert the lateral direction movement and the vertical direction movement into a rotational direction movement.

18. The method of claim 15 further comprising:
mounting, via a plurality of mounting holes of the at least one mounting chassis sequentially placed along a length of the at least one mounting chassis, corresponding motor of the plurality of motors; and
fastening, via a plurality of fastening holes fabricated proximately to each of the plurality of mounting holes, the corresponding motor with the corresponding mounting hole of the plurality of mounting holes;
wherein each of the plurality of mounting holes are positioned such that each mounting hole is offset to each other and disposed at a predefined distance along the length of the at least one mounting chassis.

19. The method of claim 15, wherein a plurality of pull rods is coupled at the first portion of the frame, wherein one end of each of the plurality of pull rods is coupled to the corresponding motor of the plurality of motors and other end of each of the plurality of pull rods is coupled to a pitch changing device, wherein the actuation of the motor of the plurality of motors facilitates to pull or push the corresponding pull rod of the plurality of pull rods to enable the pitch changing device to increase or decrease the pitch of the plurality of strings by changing pitch settings.

20. The method of claim 19, wherein the plurality of motors corresponds to at least a servomotor, a stepper motor or a linear actuator, wherein each of the motor and the corresponding pull rod is connected to a corresponding string of the plurality of strings.
